(19) United States
(12) Patent Application Publication
(10) Pub. No.: US 2014/0118293 A1
(43) Pub. Date: May 1, 2014

(54) TOUCH SENSING PANEL

(71) Applicant: NUVOTON TECHNOLOGY CORPORATION, Hsinchu (TW)

(72) Inventors: Yu-Cheng CHANG, Taichung City (TW); Ya-Nan WEN, Taipei City (TW)

(73) Assignee: NUVOTON TECHNOLOGY CORPORATION, Hsinchu (TW)

(21) Appl. No.: 13/792,183

(22) Filed: Mar. 10, 2013

(30) Foreign Application Priority Data
Oct. 31, 2012 (TW) 101221065

(51) Int. Cl. G06F 3/045

(52) U.S. Cl. CPC G06F 3/045
USPC 345/174

(57) ABSTRACT

A touch sensing panel includes first electrodes and second electrodes. The first electrodes are connected with each other. The second electrodes and the first electrodes are formed on a same surface of a substrate. The first electrodes are formed on the substrate in a first direction, and the second electrodes are formed on the substrate in a second direction which is perpendicular to the first direction. Furthermore, the second electrodes are electrically connected with each other through conductive lines, and adjacent two of the first electrodes surround one of the second electrodes.

### RELATED APPLICATIONS

This application claims priority to Taiwan Patent Application Serial Number 101221065, filed Oct. 31, 2012, which is herein incorporated by reference.

### BACKGROUND

1. Technical Field

The present disclosure relates to a sensing device. More particularly, the present disclosure relates to a touch sensing panel in a touch sensing device.

2. Description of Related Art

For high technology nowadays, user interfaces of more and more electronic products have already employed touch panels, such that demands for touch sensing devices have increasingly matured. Touch sensing devices have already become the basis of any kind of user interface, and replacing traditional keyboard interface with touch sensing interface undoubtedly makes the user interface become more intuitional and easier for use.

Moreover, one of ordinary skill in the art can use the touch sensing interface to substitute mechanical keys necessary in various applications such as access control, mobile phone, MP3 player, personal computer peripherals, remote controller, etc., and costs for manufacturing products can thus be saved.

For a conventional touch sensing device, during the fabrication of a touch sensing panel therein, it usually requires at least two steps of processes to fabricate two different electrode layers (e.g., one including electrodes formed in a column direction, and the other including electrodes formed in a row direction), such that the two different electrode layers can be utilized as driving electrodes and sensing electrodes, respectively, for touching sensing operations.

However, if the two different electrode layers are fabricated during the fabrication of the touch sensing panel, it not only needs more fabrication costs but also increases required fabrication time, and thus it is not economic.

### SUMMARY

An aspect of the present disclosure is related to a touch sensing panel.

The touch sensing panel includes a plurality of first electrodes and a plurality of second electrodes. The first electrodes are connected with each other. The first electrodes and the second electrodes are formed on a same surface of a substrate, in which the first electrodes are formed on the substrate along a first direction. The second electrodes are formed on the substrate along a second direction which is perpendicular to the first direction. The second electrodes are electrically connected with each other through conductive lines, and adjacent two of the first electrodes surround one of the second electrodes.

Another aspect of the present disclosure is related to a touch sensing panel. The touch sensing panel includes a plurality of first electrodes and a plurality of second electrodes. The first electrodes are arranged in a form of array, in which the first electrodes arranged in a first direction are connected with each other. The second electrodes and the first electrodes are formed on a same surface of a substrate. The second electrodes are interlaced with the first electrodes in a form of array, in which the second electrodes arranged in a second direction perpendicular to the first direction are electrically connected with each other through conductive lines.

Still another aspect of the present disclosure is related to a touch sensing panel. The touch sensing panel includes a plurality of driving electrodes and a plurality of sensing electrodes. The sensing electrodes and the driving electrodes are formed on a same surface. A portion of the sensing electrodes are arranged at edges of the touch sensing panel, in which the sensing electrodes which are arranged at the edges of the touch sensing panel comprises a plurality of first sensing electrodes with a first shape and a plurality of second sensing electrodes with a second shape. A portion of the first sensing electrodes are arranged at four corners of the touch sensing panel. Each of the second sensing electrodes has a top and a base, and the bases of the second sensing electrodes are arranged along the edges of the touch sensing panel.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiments, with reference to the accompanying drawings as follows:

FIG. 1 is a schematic diagram of a touch sensing panel according to one embodiment of the present disclosure; and

FIG. 2 is a schematic diagram of a touch sensing panel according to another embodiment of the present disclosure.

### DESCRIPTION OF THE EMBODIMENTS

In the following description, specific details are presented to provide a thorough understanding of the embodiments of the present disclosure. Persons of ordinary skill in the art will recognize, however, that the present disclosure can be practiced without one or more of the specific details, or in combination with other components. Well-known implementations or operations are not shown or described in detail to avoid obscuring aspects of various embodiments of the present disclosure.

The terms used in this specification generally have their ordinary meanings in the art and in the specific context where each term is used. The use of examples anywhere in this specification, including examples of any terms discussed herein, is illustrative only, and in no way limits the scope and meaning of the disclosure or of any exemplified term. Likewise, the present disclosure is not limited to various embodiments given in this specification.

As used herein, “around”, “about”, “approximately” or “substantially” shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated, or meaning other approximate values.

It will be understood that, although the terms “first,” “second,” etc., may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

As used herein, the terms “comprising,” “including”, “having,” “containing,” “involving,” and the like are to be understood to be open-ended, i.e., to mean including but not limited to.

Reference throughout the specification to “one embodiment” or “an embodiment” means that a particular feature, structure, implementation, or characteristic described in connection with the embodiment is included in at least one embodiment of the present disclosure. Thus, uses of the phrases “in one embodiment” or “in an embodiment” in various places throughout the specification are not necessarily all referring to the same embodiment. Furthermore, the particular features, structures, implementation, or characteristics may be combined in any suitable manner in one or more embodiments.

In the following description and claims, the terms “coupled” and “connected”, along with their derivatives, may be used. In particular embodiments, “connected” and “coupled” may be used to indicate that two or more elements are in direct physical or electrical contact with each other, or may also mean that two or more elements may be in indirect contact with each other. “Coupled” and “connected” may still be used to indicate that two or more elements cooperate or interact with each other.

The terms “perpendicular to” regarding the directions also include “substantially perpendicular to” throughout the specification and the claims of the present disclosure.

A touch sensing panel is disclosed below, and the touch sensing panel includes a plurality of first electrodes and a plurality of second electrodes. The first electrodes are connected with each other, and the second electrodes and the first electrodes are formed on a same surface of a substrate. The first electrodes are formed on the substrate along a first direction, and the second electrodes can be formed on the substrate along a second direction which is perpendicular to the first direction. Moreover, the second electrodes can be electrically connected with each other through conductive lines, and adjacent two of the first electrodes surround one of the second electrodes.

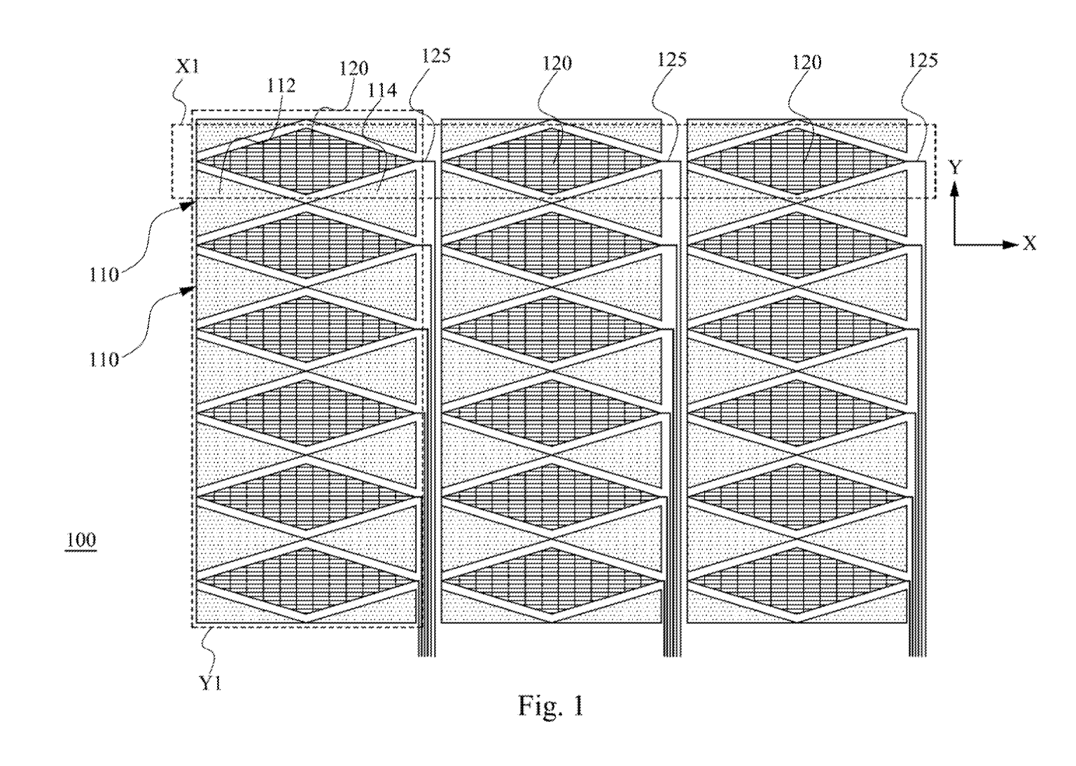

FIG. 1 is a schematic diagram of a touch sensing panel according to one embodiment of the present disclosure. As illustrated in FIG. 1, the touch sensing panel 100 includes a plurality of first electrodes 110 and a plurality of second electrodes 120, in which the second electrodes 120 and the first electrodes 110 are formed on the same surface of a substrate (not shown).

The first electrodes 110 can be formed on the substrate along a first direction (e.g., Y direction in FIG. 1, or a column direction on the touch sensing panel 100 illustrated in FIG. 1), and the second electrodes 120 can be formed on the substrate along a second direction (e.g., X direction in FIG. 1, or a row direction on the touch sensing panel 100 illustrated in FIG. 1) which is perpendicular to the first direction. Furthermore, the first electrodes 110 in the first direction are connected with each other, and the second electrodes 120 in the second direction are electrically connected with each other through conductive lines 125, such that the first electrodes 110 in the first direction are electrically conductive with each other and the second electrodes 120 in the second direction are electrically conductive with each other. Moreover, the adjacent two of the first electrodes 110 surround one of the second electrodes 120.

For example, as illustrated in FIG. 1, the first electrodes 110 shown within a dashed-line box Y1 can be formed along the Y direction on the substrate, and the first electrodes 110 shown within the dashed-line box Y1 are connected with each other, such that the first electrodes 110 in the Y direction are electrically conductive with each other. Moreover, the second electrodes 120 shown within a dashed-line box X1 can be formed along the X direction on the substrate, and the second electrodes 120 shown within the dashed-line box X1 are electrically connected with each other through the conductive lines 125, such that the second electrodes 120 in the X direction are electrically conductive with each other.

In practice, each of the second electrodes 120 in the second direction can be connected with one conductive line 125, and the conductive lines 125 may be dragged outside the touch sensing panel 100, for example, along the Y direction (or the column direction on the touch sensing panel 100) shown in FIG. 1, and the conductive lines 125 may be substantially connected or integrated in a circuit board, an integrated circuit (IC) or other circuits outside the touch sensing panel 100 or may be virtually connected in the form of algorithm outside the touch sensing panel 100, such that the second electrodes 120 in the second direction can be electrically connected with each other through the conductive lines 125 (for example, the second electrodes 120 arranged in the X direction can be electrically connected with each other through the conductive lines 125).

During a fabrication process of a conventional touch sensing panel (e.g., the sensing panel suitable for multi-touch control application), it is mostly necessary that two different electrode layers (e.g., one including electrodes or conductors formed in the column direction, and the other including electrodes or conductors formed in the row direction) are fabricated separately, such that the two different layers of electrodes are formed to be the driving electrodes and the sensing electrodes, respectively, for touching sensing operations. Therefore, there has to be at least two steps of processes for fabricating the electrodes or the conductors during the fabrication process, and thus it is not only complex but also cannot save fabrication cost and time effectively.

Compared to that, for the touch sensing panel 100 in the embodiment of the present disclosure described above, the electrodes in different directions can be formed on the same surface of the substrate, and thus the required step(s) of process can be saved so as to simplify the fabrication process effectively and to reduce the required fabrication cost and time correspondingly.

In addition, the first electrodes 110 in the first direction are electrically conductive with each other and the second electrodes 120 in the second direction are electrically conductive with each other. As a result, the first electrodes 110 and the second electrodes 120 both arranged in the form of array can be implemented respectively to be the driving electrodes and the sensing electrodes (or to be the sensing electrodes and the driving electrodes, respectively), such that the electrodes arranged in the form of array can be configured to perform the corresponding touch sensing operations. Moreover, compared to other touch sensing panels with single one layer of electrode, the touch sensing panel 100 in the embodiment of the present disclosure can have better sensing accuracy and sensitivity, for example, in regard to the multi-touch sensing operations.

Furthermore, since the touch sensing panel 100 in the embodiment of the present disclosure includes the electrodes arranged, for example, in the form of array (i.e., the form of multiple columns crossing multiple rows), the operation circuits originally suitable for the electrodes in the form of double-layer arrays can be applied thereto as well, and thus it is unnecessary to increase or design extra circuits or algorithms, thereby reducing the costs necessary for developing new circuits or algorithms.

In one embodiment, each of the second electrodes 120 can have a shape of circle or polygon (e.g., each is a quadrilateral electrode), and each of the first electrodes 110 can have a shape of another polygon corresponding to the shape of polygon, e.g., each is a polygonal electrode which is complementary with the quadrilateral electrode.

In a specific embodiment, as shown in FIG. 1, each of the first electrodes 110 may include two polygonal electrodes (e.g., triangular electrode, trapezoid electrode, etc.), and each of the two polygonal electrodes has a top and a base, in which the tops of the two polygonal electrodes are oppositely connected. For example, each of the first electrodes 110 may include triangular electrodes 112, 114, in which the tops of the triangular electrode 112 and the triangular electrode 114 are oppositely connected, and each of the second electrodes 120 can be a quadrilateral electrode (e.g., a diamond or square electrode) or a circular electrode.

Furthermore, as shown in FIG. 1, the bases of the polygonal electrodes of the first electrodes 110 in the first direction are connected with each other, such that the first electrodes 110 in the first direction are connected with each other. For example, the bases of the triangular electrodes 112 are connected with each other, such that the first electrodes 110 in the first direction are connected with each other. In practice, the bases of the triangular electrodes 112 may be formed at the same time during fabrication to be connected with each other (for example, through formed connector electrodes) and also may be connected with each other through additional conductive lines after fabrication. In addition, it is another choice that the bases of the triangular electrodes 112 are not connected with each other but the bases of the triangular electrodes 114 are connected with each other in the first direction. In other words, persons of ordinary skill in the art may modify and change the aforementioned embodiments according to practical needs or designs, and thus it is not limiting of the present disclosure.

On the other hand, as shown in FIG. 1, the first electrodes 110 (for example, the polygonal electrode including the triangular electrodes 112, 114, or the polygonal electrode including two trapezoid electrodes) can be arranged in the form of array (i.e. the form of multiple columns crossing multiple rows), and the second electrodes 120 (e.g., the polygonal electrode or circular electrode) also can be interlaced with the first electrodes 110 (e.g. the polygonal electrode) in the form of array on the same surface of the substrate. Moreover, the first electrodes 110 (e.g., the polygonal electrode) in the first direction are connected with each other, and the second electrodes 120 (e.g., the polygonal electrode or circular electrode) in the second direction which is perpendicular to the first direction are electrically connected with each other through the conductive lines 125, such that the first electrodes 110 and the second electrodes 120 both arranged in the form of array can be implemented respectively to be the driving electrodes and the sensing electrodes (or to be the sensing electrodes and the driving electrodes, respectively) provided for performing corresponding touch sensing operations.

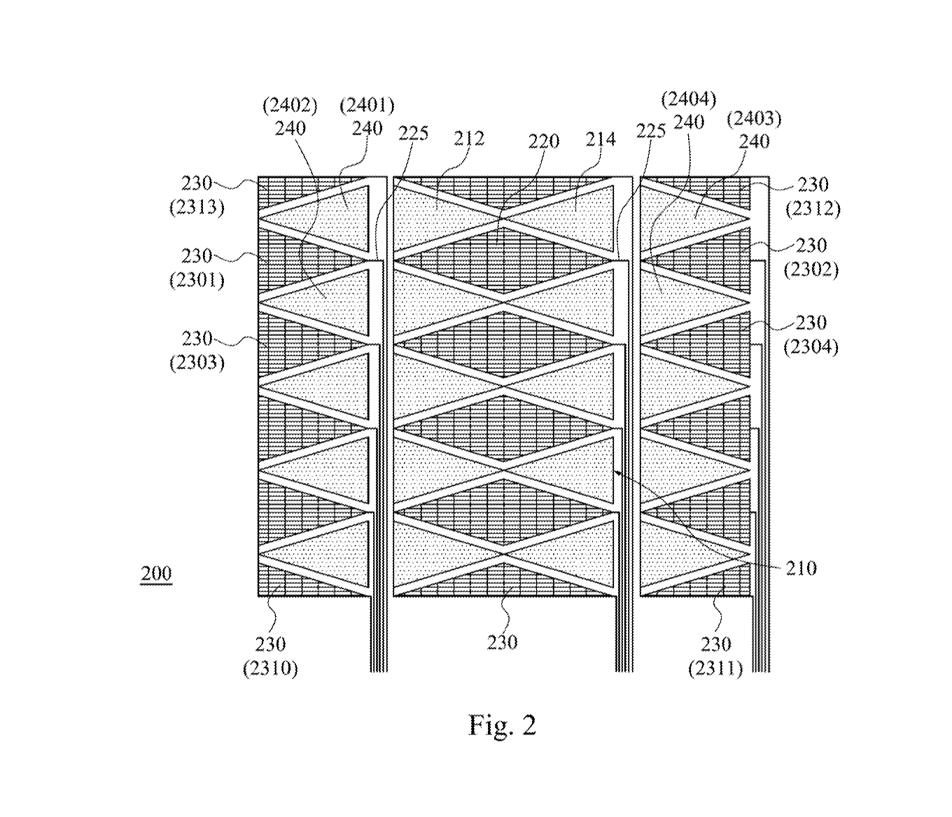

FIG. 2 is a schematic diagram of a touch sensing panel according to another embodiment of the present disclosure. As illustrated in FIG. 2, the touch sensing panel 200 includes a plurality of first electrodes 210 and a plurality of second electrodes 220, in which each of the first electrodes 210 may also include two polygonal electrodes (e.g., triangular electrodes 212, 214, or trapezoid electrodes). The arrangements, connections, and embodiments of the first electrodes 210 and the second electrodes 220 are similar to those illustrated in FIG. 1, and thus they are not further detailed herein.

Compared to the embodiment illustrated in FIG. 1, in FIG. 2, the touch sensing panel 200 may further include a plurality of third electrodes 230, in which the third electrodes 230 and the second electrodes 220 are formed on the same surface of the substrate, and the third electrodes 230 can be respectively arranged along edges of the touch sensing panel 200 (compared to that the first electrodes 110 in FIG. 1 are respectively arranged along the edges of the touch sensing panel 100) and are electrically connected with the second electrodes 220 through conductive lines 225 in the first direction (e.g., row or column direction), which are similar to the connections of the second electrodes 220, such that the third electrodes 230 and the second electrodes 220 are electrically conductive with each other to be sensing electrodes (or driving electrodes) together.

In one embodiment, the third electrodes 230 can include third polygonal electrodes (e.g., triangular electrodes, trapezoid electrodes, etc.), each of the third polygonal electrodes has a top and a base (in which a width of the base is larger than a width of the top), the bases thereof are arranged along the edges of the touch sensing panel 200, the top of at least one of the third polygonal electrodes is electrically connected with the second electrodes 220 through the conductive lines 225, and the base of at least one of the third polygonal electrodes is electrically connected with the second electrodes 220 through the conductive lines 225.

For example, the third electrodes 230 may include triangular electrodes (e.g., triangular electrodes 2301, 2302, 2303, 2304, etc.), in which the bases of the triangular electrodes 2301, 2302, 2303, 2304 are respectively arranged along the edges of the touch sensing panel 200, and the triangular electrodes 2301 2302, 2303, 2304 are arranged in the form of array corresponding to the second electrodes 220. In addition, the triangular electrodes 2301, 2303 can be arranged in the same column, the triangular electrodes 2302, 2304 can be arranged in the same column, the triangular electrodes 2301, 2302 can be arranged in the same row as well as the same row of the second electrodes 220, the triangular electrodes 2303, 2304 can be arranged in the same row as well as another row of the second electrodes 220, and the rest may be deduced by analogy.

Since the bases of the triangular electrodes 2301, 2302, 2303, 2304 are respectively arranged along the edges of the touch sensing panel 200, the sensing effect of the edges of the touch sensing panel 200 can be further improved if the triangular electrodes 2301, 2302, 2303, 2304 are implemented as the sensing electrodes.

Moreover, the tops of the triangular electrodes 2301, 2303, etc. can be electrically connected with the second electrodes 220 in the corresponding row through the conductive lines 225, and the bases of the triangular electrodes 2302, 2304, etc. can be electrically connected with the second electrodes 220 in the corresponding row through the conductive lines 225, such that the triangular electrodes 2301, 2302, 2303, 2304, etc. are electrically conductive with the second electrodes 220 in the corresponding rows to be the sensing electrodes (or the driving electrodes) together.

For the embodiment illustrated in FIG. 2, in the condition that the first electrodes 210 can be implemented as the driving electrodes and the second electrodes 220 and the third electrodes 230 can be implemented as the sensing electrodes, the third electrodes 230 are arranged at the edges of the touch sensing panel 200, and the third electrodes 230 include a plurality of first sensing electrodes (e.g., sensing electrodes 2310-2313) with a first shape and a plurality of second sensing electrodes (e.g., triangular electrodes 2301-2304) with a second shape, in which the first sensing electrodes (e.g., sensing electrodes 2310-2313) are arranged at four corners of the touch sensing panel 200, each of the second sensing electrodes (e.g., triangular electrodes 2301-2304) has a top and a base, and the bases of the second sensing electrodes (e.g., triangular electrodes 2301-2304) are arranged along the edges of the touch sensing panel 200. Since the sensing electrodes are arranged along the edges of the touch sensing panel 200, the sensing effect of the edges of the touch sensing panel 200 can be further improved.

On the other hand, in FIG. 2, the touch sensing panel 200 may further include a plurality of fourth electrodes 240, in which the fourth electrodes 240 and the first electrodes 210 are formed on the same surface of the substrate, and the fourth electrodes 240 and the third electrodes 230 are arranged alternately. In addition, the fourth electrodes 240 are connected with each other in each column (or row) and, in practice, may be formed at the same time during fabrication to be connected with each other (for example, through formed connector electrodes) and also may be connected with each other through additional conductive lines after fabrication, which are similar to the connections of the first electrodes 210.

In one embodiment, the fourth electrodes 240 can also include a plurality of fourth polygonal electrodes (e.g., triangular electrodes, trapezoid electrodes, etc.), each of the fourth polygonal electrodes has a top and a base (in which a width of the base is larger than a width of the top), and the fourth polygonal electrodes and the third electrodes 230 (or the third polygonal electrodes) are inversely and alternately arranged. For example, the fourth electrodes 240 may include triangular electrodes (e g. triangular electrodes 2401, 2402, 2403, 2404, etc.), and the triangular electrodes 2401, 2402, 2403, 2404, etc. can be arranged in the form of array corresponding to the first electrodes 210, in which the triangular electrodes 2401, 2402, 2403, 2404, etc. and the triangular electrodes 2301, 2302, 2303, 2304, etc.) can be inversely and alternately arranged (as shown in FIG. 2). Furthermore, the triangular electrodes 2401, 2402 can be close to the left edge of the touch sensing panel 200 and arranged in the same column, and the triangular electrodes 2403, 2404 can be close to the right edge of the touch sensing panel 200 and arranged in the same column.

Moreover, in another embodiment, the tops of at least two of the fourth polygonal electrodes can be connected with each other, and the bases of at least two of the fourth polygonal electrodes can be connected with each other. For example, as shown in FIG. 2, the tops of the triangular electrodes 2401, 2402, etc. in the same column can be connected with each other and the bases of the triangular electrodes 2403, 2404, etc. in the same column can be connected with each other, in which, in practice, they can be formed at the same time during fabrication to be connected with each other (for example, through formed connector electrodes) and also may be connected with each other through additional conductive lines after fabrication.

The aforementioned embodiment is described by the example of the third electrodes 230 arranged in the rows and the fourth electrodes 240 arranged in the columns. However, persons of ordinary skill in the art can utilize the arrangement of the third electrodes 230 arranged in the columns and the fourth electrodes 240 arranged in the rows according to practical needs; in other words, persons of ordinary skill in the art may modify and change the aforementioned embodiments according to practical needs or designs, and thus it is not limiting of the present disclosure.

For the aforementioned embodiments, the touch sensing panel of the present disclosure can be applied such that not only can the required step(s) of process be saved so as to simplify the fabrication process effectively and to reduce the required fabrication cost and time correspondingly, but also can the touch sensing panel be maintained to have better sensing accuracy and sensitivity (for example, in regard to the multi-touch sensing operations). In addition, it unnecessary to increase or design extra circuits or algorithms, thereby reducing the costs necessary for developing new circuits or algorithms.

As is understood by a person skilled in the art, the foregoing embodiments of the present disclosure are illustrative of the present disclosure rather than limiting of the present disclosure. It is intended to cover various modifications and similar arrangements included within the spirit and scope of the appended claims, the scope of which should be accorded with the broadest interpretation so as to encompass all such modifications and similar structures.

What is claimed is:

1. A touch sensing panel comprising:
a plurality of first electrodes connected with each other; and
a plurality of second electrodes, the first electrodes and the second electrodes being formed on a same surface of a substrate, wherein the first electrodes are formed on the substrate along a first direction, the second electrodes are formed on the substrate along a second direction which is perpendicular to the first direction, the second electrodes are electrically connected with each other through conductive lines, and adjacent two of the first electrodes surround one of the second electrodes.

2. The touch sensing panel as claimed in claim 1, wherein each of the second electrodes has a shape of quadrilateral, and each of the first electrodes has a shape of polygon corresponding to the shape of quadrilateral.

3. The touch sensing panel as claimed in claim 1, wherein each of the first electrodes comprises a first polygonal electrode and a second polygonal electrode, each of the first polygonal electrode and the second polygonal electrode has a top and a base, the tops of the first polygonal electrode and the second polygonal electrode are oppositely connected, and the bases of the first polygonal electrodes of the first electrodes are connected with each other.

4. The touch sensing panel as claimed in claim 3, wherein each of the second electrodes is a corresponding polygonal electrode or a circular electrode corresponding to the first electrodes.

5. The touch sensing panel as claimed in claim 4, further comprising:
a plurality of third electrodes, the third electrodes and the second electrodes being formed on the same surface of the substrate, wherein the third electrodes are respectively arranged along edges of the touch sensing panel and electrically connected with the second electrodes through conductive lines.

6. The touch sensing panel as claimed in claim 3, further comprising:
a plurality of third electrodes, the third electrodes and the second electrodes being formed on the same surface of the substrate, wherein the third electrodes are respectively arranged along edges of the touch sensing panel and electrically connected with the second electrodes through conductive lines.

7. The touch sensing panel as claimed in claim 6, wherein the third electrodes comprises a plurality of third polygonal electrodes, each of the third polygonal electrodes has a top and a base, the bases of the third polygonal electrodes are arranged along the edges of the touch sensing panel, the top of at least one of the third polygonal electrodes is electrically connected with the second electrodes through the conductive lines, and the base of at least one of the third polygonal electrodes is electrically connected with the second electrodes through the conductive lines.

8. The touch sensing panel as claimed in claim 6, further comprising:
a plurality of fourth electrodes, the fourth electrodes and the first electrodes being formed on the same surface of the substrate, wherein the fourth electrodes and the third electrodes are arranged alternately.

9. The touch sensing panel as claimed in claim 8, wherein the fourth electrodes comprises a plurality of fourth polygonal electrodes, each of the fourth polygonal electrodes has a top and a base, the tops of at least two of the fourth polygonal electrodes are connected with each other, and the bases of at least two of the fourth polygonal electrodes are connected with each other.

10. A touch sensing panel comprising:
a plurality of first electrodes arranged in a form of array, wherein the first electrodes arranged in a first direction are connected with each other; and
a plurality of second electrodes, the second electrodes and the first electrodes being formed on a same surface of a substrate, the second electrodes being interlaced with the first electrodes in a form of array, wherein the second electrodes arranged in a second direction perpendicular to the first direction are electrically connected with each other through conductive lines.

11. The touch sensing panel as claimed in claim 10, wherein each of the first electrodes comprises a first polygonal electrode and a second polygonal electrode, each of the first polygonal electrode and the second polygonal electrode has a top and a base, and the tops of the first polygonal electrode and the second polygonal electrode are oppositely connected.

12. The touch sensing panel as claimed in claim 11, wherein the bases of the first polygonal electrodes of the first electrodes arranged in the first direction are connected with each other.

13. The touch sensing panel as claimed in claim 12, wherein each of the first polygonal electrode and the second polygonal electrode is a triangular electrode or a trapezoid electrode.

14. The touch sensing panel as claimed in claim 11, further comprising:
a plurality of third polygonal electrodes, the third polygonal electrodes and the second electrodes being formed on the same surface of the substrate, each of the third polygonal electrodes having a top and a base, wherein the bases of the third polygonal electrodes are respectively arranged along the edges of the touch sensing panel.

15. The touch sensing panel as claimed in claim 14, wherein the top of at least one of the third polygonal electrodes is electrically connected with the second electrodes arranged in the second direction through conductive lines, and the base of at least one of the third polygonal electrodes is electrically connected with the second electrodes arranged in the second direction through conductive lines.

16. The touch sensing panel as claimed in claim 14, further comprising:
a plurality of fourth polygonal electrodes, the fourth polygonal electrodes and the first electrodes being formed on the same surface of the substrate, each of the fourth polygonal electrodes having a top and a base, wherein the fourth polygonal electrodes and the third polygonal electrodes are inversely and alternately arranged.

17. A touch sensing panel comprising:
a plurality of driving electrodes; and
a plurality of sensing electrodes, the sensing electrodes and the driving electrodes being formed on a same surface, a portion of the sensing electrodes being arranged at edges of the touch sensing panel, wherein the sensing electrodes which are arranged at the edges of the touch sensing panel comprises a plurality of first sensing electrodes with a first shape and a plurality of second sensing electrodes with a second shape, wherein a portion of the first sensing electrodes are arranged at four corners of the touch sensing panel, each of the second sensing electrodes has a top and a base, and the bases of the second sensing electrodes are arranged along the edges of the touch sensing panel.
